(19) United States
(12) Patent Application Publication
(10) Pub. No.: US 2009/0198547 A1
(43) Pub. Date: Aug. 6, 2009

(54) Catering method and system

(76) Inventor: Michael Paul Sudak, Arvada, CO (US)

Correspondence Address: BARBER LEGAL, P.O. BOX 16220, GOLDEN, CO, 80402-6004, US

(21) Appl. No.: 12/011,862

(22) Filed: Jan. 31, 2008

(51) Int. Cl. G06Q 10/00; G06Q 20/00

(52) U.S. Cl. 705/8

(57) ABSTRACT

A single caterer or multiple caterers may provide individualized meals for a large number of customers at a number of different institutions. A server computer has individual accounts for each customer, caterer, institution accounts grouping the customers by the institution with which they are affiliated, and an administration account for management functions and kitchen related modules such as preparation sheets. Significantly, with the method of the invention that relationship need not include any food preparation, billing for food, or menu collation, creation or the like by the institution. The kitchen will prepare a monthly menu of options available to the customers, who use individual accounts to access the monthly menu of choices and select menu options for each day and pay the caterer using a payment module. The catering system of the invention then handles payments to the caterers.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever. 37 CFR 1.71(d).

### CROSS-REFERENCE TO RELATED APPLICATIONS

N/A

### FIELD OF THE INVENTION

This invention relates generally to catering methods, and specifically to multi-facility catering.

### STATEMENT REGARDING FEDERALLY FUNDED RESEARCH

This invention was not made under contract with an agency of the US Government, nor by any agency of the US Government.

### BACKGROUND OF THE INVENTION

Catering of meals usually falls into several broad traditional categories.

There is single institution catering, in which a single institution such as a school will maintain the expense of a kitchen and kitchen staff, and the kitchen staff will be required to do tedious and time consuming ordering, bookkeeping, accounting and similar tasks in addition to their nominal task of food preparation. The single greatest drawback with single institution catering is that below a certain size of institution, provision of a kitchen and staff is economically impossible.

Another model of catering is the provision of a single event catering, in which an expensive “on call” catering business will cater single events such as weddings, parties and so on. The drawback with this model is the extreme cost: due to the high cost such catering is only available occasionally.

A third model of catering is multiple institution catering in which a catering business supplies a single meal to a number of institutions, thus splitting the cost of the catering business' kitchen facility and staff over a number of organizational customers such as smaller schools or the like. However, the weakness with this model is that since the food preparation facility is removed from the end customers, there is no real flexibility in terms of menu: the choice of food which is transported to the eating location (such as a smaller school) is the only choice available at the time of eating.

Obviously, the enormous overhead for a school or institute to offer menu choices, collect responses from students and,then get these to a caterer make it virtually impossible to allow any economically practical ordering by individuals of their menu choice at the eating location. Pre-cooking excess amounts of food in order to offer any possible menu choice to each individual would result in a vast over-preparation of food, wastage, and greatly increased cost.

Thus up until the present time, it appears to have been impractical to offer individual choice in institutional catering.

The present invention teaches a new model of catering which allows individuals to pre-order their desired menu from the catering organization without the intervention of the organizational customer. Thus the organization customer does not have to do accounting, ordering, food preparation and so on, yet the individual customer has the option to select their menu.

### SUMMARY OF THE INVENTION

General Summary

The present invention teaches that a single catering institution/kitchen or multiple catering institutions using the invention may provide individualized meals for a large number of customers (such as students) at a number of different institutions (such as schools). A server computer has individual accounts for each customer, institution accounts grouping the customers by the institution with which they are affiliated, and an administration account for management functions and kitchen related modules such as preparation sheets detailing the menu items and quantities which must be prepared on a daily basis.

Schools and the individuals who attend them have a normal relationship and normal communications. Significantly, with the method of the invention that relationship need not include any food preparation, billing for food, or menu collation, creation or the like by the institution. The individual customer continues their normal relationship with the institution but in actuality deals directly with the kitchen/caterer in regard to menu, food, and payments therefor.

In practice, a school or kitchen will prepare a monthly menu of options available to the customers. The customers or their guardians will log onto the system using the individual accounts available and will access the monthly menu of choices. Customers then select their menu options for each day (such as “nothing”, “drink only”, “hot dog”, “salad”, and so on), and the individual customer then pays using a payment module (such as PAYPAL (tm) or any other convenient system) the catering system (on behalf of the kitchen), not the school or other institution. The result is that the school does not need to handle money, menus, individual dietary preferences or the like.

The customers may select from menus offered by multiple different caterers, in fact, possibly even ordering one item from a first caterer and a second item from a second caterer, perhaps even during the exact same meal.

The kitchen uses the system of the invention to collate the menu preparation necessary on any given day and arrange for production and transportation of the food to the individual institutions. The institution receives an exact list of the users/consumers arranged by grade/department/alphabetically, and their exact order. Thus the individual customers are introduced to the kitchen/caterer via the institution, eat at the institution, and only on-line when selecting and paying for menu choices for the next month or other menu period does the customer actually even need to realize (and may not even realize when ordering) that they are dealing with a third entity, the caterer or a fourth entity, the catering system.

### SUMMARY IN REFERENCE TO CLAIMS

It is therefore another aspect, advantage, objective and embodiment of the invention, in addition to those discussed previously, to provide a catering method for individual customers of a first institution with which the individual customers are associated, the catering method comprising the steps of:
0) provision of a catering system operative to communicate with such individual customers, a first caterer, and such first institution;
1) provision via such catering system by the first caterer to such individual customers of a schedule and a set of menu items associated with such first institution;
2) selection via such catering system by such customers of a subset of the menu items;
3) return via the catering system by the customers of the selected subset to the caterer, not the institution;
4) payment via the catering system by the customers to the caterer;
5) provision of the selected subset of the menu items by the caterer to the institution according to the schedule.

It is therefore another aspect, advantage, objective and embodiment of the invention to provide a catering method wherein the step of provision of a schedule and a set of menu items associated with such first institution further comprises:
provision of a website having the schedule and set of menu items thereon; and
provision of customer accounts individually associated with the customers of the institution.

It is therefore another aspect, advantage, objective and embodiment of the invention to provide a catering method wherein the step of selection of a subset of the menu items further comprises:
provision of a selection module of such customer accounts, the selection module operative to allow selection of the subset; and
provision of an administrator account operative to receive such selections.

It is therefore another aspect, advantage, objective and embodiment of the invention to provide a catering method wherein the step of payment further comprises:
provision of a payment module of such customer accounts operative to allow electronic payment by the customer to the caterer without intervention of the institution.

It is therefore another aspect, advantage, objective and embodiment of the invention to provide a catering system for use by individual customers of a first institution with which the individual customers are associated, the catering system comprising:
a food preparation center having a delivery vehicle operative to deliver prepared food to such institution;
a website having thereon a schedule, a set of menu items associated with the schedule, and at least one individual account associated with each such individual customer, the individual account associated with each such individual customer further comprising a payment module operative to provide payment from the individual customer to an administrative account, the administrative account having a food preparation module operative to provide food preparation information to the food preparation center.

It is therefore yet another aspect, advantage, objective and embodiment of the invention to provide a catering system further comprising:
a menu preparation module operative to provide the schedule and set of menu items associated therewith.

It is therefore another aspect, advantage, objective and embodiment of the invention to provide a catering system further comprising:
an administrative customer account management module operative to setup and control individual customer accounts.

It is therefore another aspect, advantage, objective and embodiment of the invention to provide a catering system further comprising:
an institution management module operative to control an institution account associated with each institution.

It is therefore another aspect, advantage, objective and embodiment of the invention to provide a catering system further comprising:
a meal management module operative to allow creation of the set of menu items for later customer selection.

It is therefore another aspect, advantage, objective and embodiment of the invention to provide a catering system further comprising:
a report module operative to provide a report selected from the group consisting of:
customer menu selections by date and institution; food production necessary to fulfill customer menu selections by date; food production necessary to fulfill customer menu selections by institution; financial accounting reports and combinations thereof.

### BRIEF DESCRIPTION OF THE DRAWINGS

FIG. 1 is a block diagram of a preferred embodiment of the device in the system domain, showing ordering, administration and similar nodes.

FIG. 2 is a block diagram of one preferred embodiment of the device in the physical domain, showing physical components of the system.

FIG. 3 is a screen view of an individual order detail calender module for a month.

FIG. 4 is a screen view of a school menu calender module for a month.

FIG. 5 is a screen view of an individual order detail showing details of cost and payment.

FIG. 6 is a screen view is a screen view of an administrative function selection module showing various options for administrative management of the system of the invention.

FIG. 7 is a screen view of a school management function selection module showing various options available for a school's administrative management of the system of the invention.

FIG. 8 is a screen view of an administrative management module controlling customer accounts on the system of the invention.

FIG. 9 is a screen view of a meal management module controlling building of meals on the system of the invention.

FIG. 10 is a screen view of a report module showing a single day and a single institution (school) and the menu choices of individual customers (students) at the institution.

FIG. 11 is a screen view of a production sheet for kitchen use, showing the various items to be produced on a single day.

FIG. 12 is a block diagram of the preferred embodiment of the device in the physical domain, showing physical components of the system.

### INDEX TO REFERENCE NUMERALS

| | |
|---|---|
| Server computer | 102 |
| Customer account information | 104 |
| Institutional account information | 106 |
| Administrator account information | 108 |
| Internet | 110 |
| Customer computer | 112 |
| School administrator computer | 114 |
| Administrator computer | 116 |
| School/institution | 202 |
| Home/individual customer | 204 |
| Institution/individual relationship and communication | 206 |
| Administration and kitchen facilities | 208 |
| Institution to system management | 210 |
| System-institution management, billing and food delivery | 212 |
| Administrative/individual communications | 214 |
| School/institution | 1202 |
| Home/individual customer | 1204 |
| Institution/individual relationship and communication | 1206 |
| Caterer to institution services | 1210 |
| Food deliveries | 1212 |
| Administration/system management | 1250 |
| Caterer facilities | 1252 |
| Administration communication/payment to caterer | 1254 |
| Institution to system management communication | 1256 |

### DETAILED DESCRIPTION

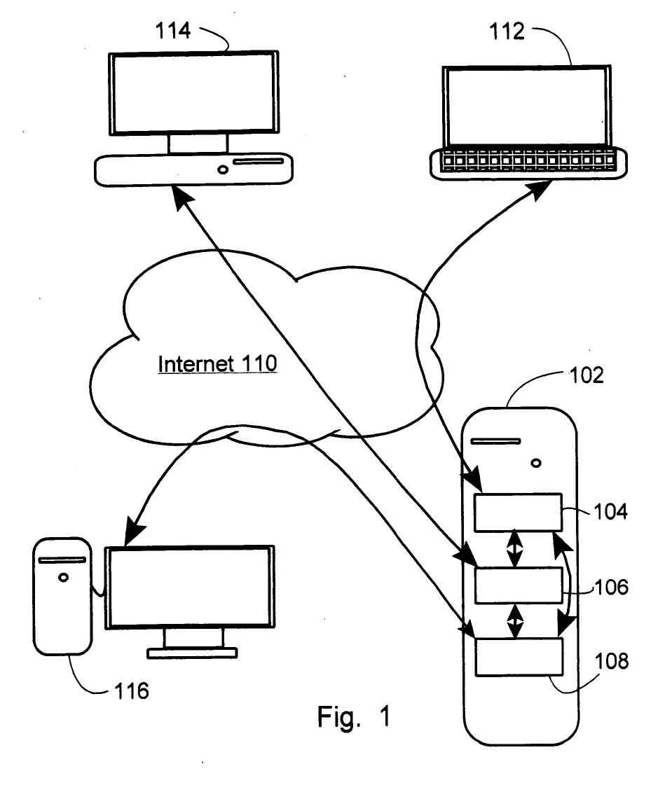

FIG. 1 is a block diagram of a preferred embodiment of the device in the system domain, showing ordering, administration and similar nodes. In the presently preferred embodiment and best mode presently contemplated for carrying out the invention, server computer 102 has therein at least two types of accounts, possibly three. Customer account information 104 is a customer account area having customer accounts therein, each account having various functions, modules and stored data associated with that customer. Such information could include menu options selected by date (March 29^{th}, PASTA selected, MILK selected, SALAD not selected, CHEESEBURGER not selected, FRIES not selected), passwords, financial information such as amounts owed or paid and so on. A payment module is designed to allow easy payment. Importantly, the institution with which the customer has a relationship need NOT be involved in either menu selection or payments from customer to caterer, thus substantially removing the burdens of catering from the institution. Note that by means of co-branding, in alternative embodiments the system may use the trademarks and name of the institution, thus offering the customer the appearance of a seamless experience with the institution and the presence and activities of the caterer may have reduced visibility, even though the customers (or their parents) may have daily interactions with the “invisible” caterer.

As an example, students Michael Sudak and Bill Smith might each have an account, on which account they are functionally dealing directly with the catering organization, not the institution with which they have prior association, and at which the meals actually take place, such as a school.

Institutional account information 106 on the other hand is an institutional account area having institutional accounts therein, each account having various functions, modules and stored data associated with that customer. Institutions which might use the system of the invention include schools, especially smaller schools, but also venues which from time to time host events (hotels, convention centers, churches, pubs, granges, community centers, public government units and so on and so forth), and involuntary stay facilities such as smaller correctional facilities or the like.

The institution may be in charge of menu building or may cooperate with the catering organization in generalized menu planning. The best mode now contemplated for carrying out the invention teaches that the institution and the catering organization cooperate on this: the institution may lay out general parameters (“The Mahayana-Randite Institute is strictly vegen” or the like) and then the catering organization actually assembles complying menus.

Administrator account information 108 includes the largest and most important part of the system. The administrative functions and module are diverse, including setup and control of individual accounts, setup and control of school/institution accounts, creation of menu items, creation of menu sets, creation of schedules of the menus and so on.

Internet 110 is a preferred device for offering the service method of the invention. By the use of the protocols and formats associated with the Internet (HTML, XML, Java, and so on) a quick and easy connection may be established from customer computer 112 and/or school administrator computer 114 to the administrator computer 116, which may obviously be a server computer. Thus the accounts may be preferably embodied as websites. Testing has revealed that this method is convenient for all concerned, though it is not necessary to use the Internet (an IVR telephone system may be used or the like, a text message based system may be used, or a non-electronic embodiment may be used).

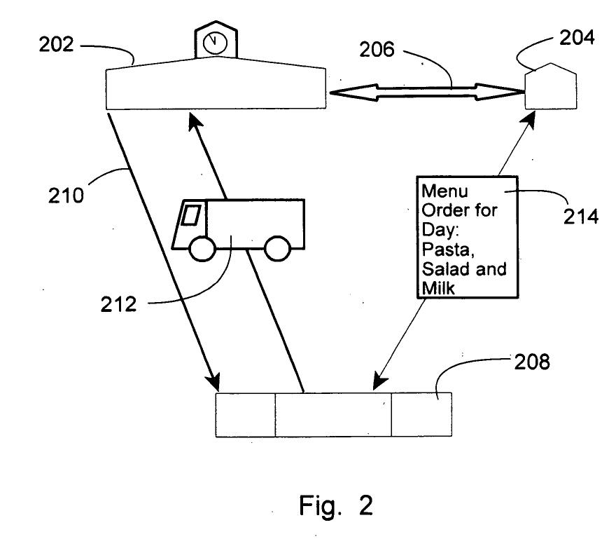

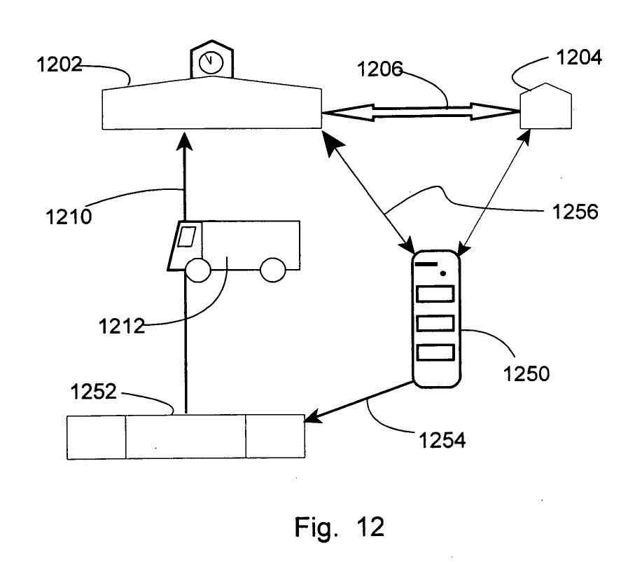

FIG. 2 is a block diagram of one preferred embodiment of the device in the physical domain, showing physical components of the system when the caterer and the system are one and the same, that is the administrative system is combined with catering. (FIG. 12 addresses the situation when the two functions are separated.)

School/institution 202 and home/individual customer 204 have an institution/individual relationship and communication 206 which may presumably take the form of daily attendance or the like, websites, newsletters and so on. In the case of minor customers (students below age 17) the “customer” may functionally be the household, parent, guardian, etc. The addition of the entire catering organization to the relationship can be very convenient: the system of the invention may be connected to the school website or the like.

Administration and kitchen facilities 208 are the physical location at which meals are prepared, the catering system is managed and so on, and such facilities may be broken up into several different locations.

Institution to system management 210 is the ability of the “institutional customer” to have input and control over the catering process: times of lunch, requirements for new students to be added to the catering system, details of acceptable menu plans and so on. If the institution wishes to assume the burden of billing transactions or menu selection, that can be accommodated, although at the cost of giving up a great deal of the freedom offered by the present system, a somewhat self-defeating choice.

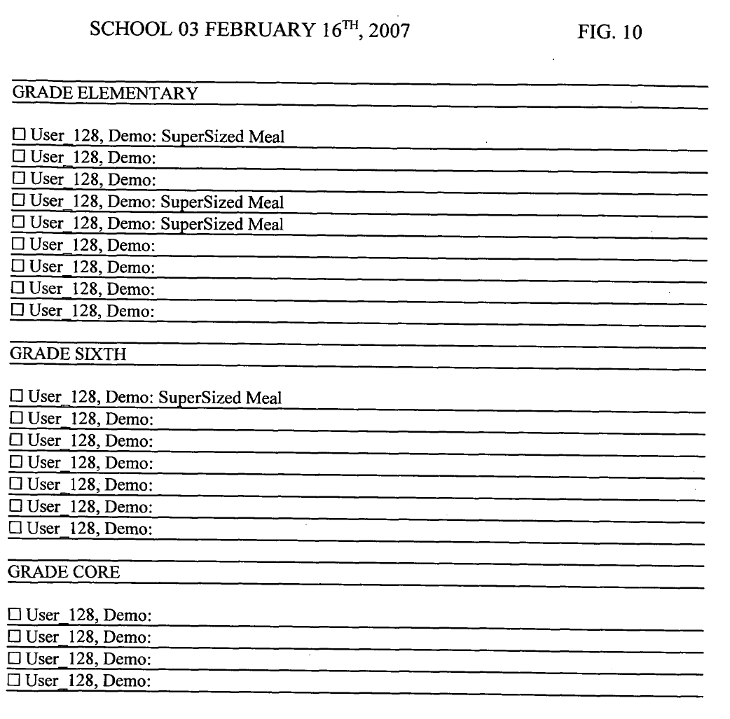

System-institution management, billing and food delivery 212 flow in the opposite direction: the caterer/system informs the school of which student has ordered what menu option for a given day by means of a daily report (see FIG. 10). Of course, the FIG. 2 food delivery 212 may occur by means of a delivery vehicle such as most caterers already have, however, when the vehicle is supplied with prepared food from the kitchen facility 208, it goes out with a mixture of menu items corresponding to the choices of the customers and a list of which customer has ordered what item. This ability to pre-load a catering vehicle with individual choices, and do it an economically sensible manner, or to allow ordering of a variety of items from multiple suppliers (multiple caterers or restaurants on one truck, or multiple caterers sending multiple trucks) sets the present invention apart from known institutional catering methods and systems.

FIG. 12 is a block diagram of the preferred embodiment of the device in the physical domain, showing physical components of the system. As discussed in regard to FIG. 2, school/institution 1202 and home/individual customer 1204 have a relationship and communication 1206: educational, financial and so on.

By using the system of the invention, the addition of the one OR MORE catering organizations to the relationship can be made painless and quite convenient: the system of the invention may be “seamlessly” connected to the school website or may be combined pool system used by multiple schools and/or caterers.

Kitchen facilities 1252 are the first physical location at which meals are prepared, but in this embodiment the catering system of the invention is NOT managed at the caterer 1252, rather, the facilities may be broken up into several different locations such as administrative center 1250.

School/institution 1202 and home/individual customer 1204 deal with communications with the system 1250 largely as previously discussed in relation to FIG. 2, however, caterer to institution services 1210 no longer need have ANY financial component. In fact, the sum of the services may become as simple as food deliveries 1212, with both parties having the burden of other transactions removed. Instead, administration/system management 1250 handles receipt of orders from the customers and payments from the customers, then passes payments on to the caterer facilities 1252 via administration communication/payment to caterer 1254. Institution to system management communication 1256 may also be vastly simplified.

Note that as a result of this favored embodiment of the invention, the limitation to a single caterer has been removed. The institution can now economically have serve it as many caterers as wish to serve it, because the institution no longer bears any responsibility for the caterers (with the obvious exception of want to assure its customers of the reliability of caterers serving it.) The system of the invention allows multiple caterers to deliver to the same meal at the same institution if the demand is there, and thus allows parents to select the catering and menu items which work best for them.

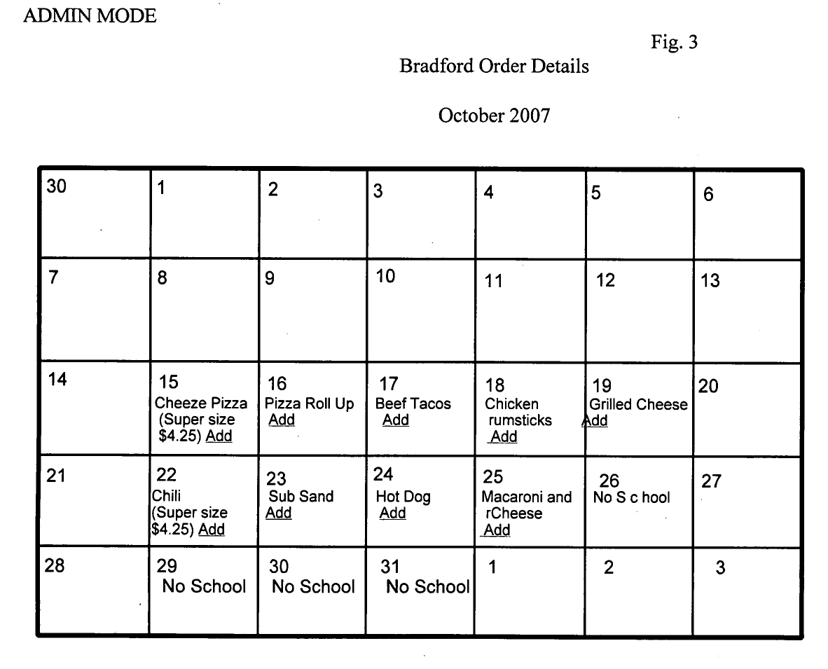

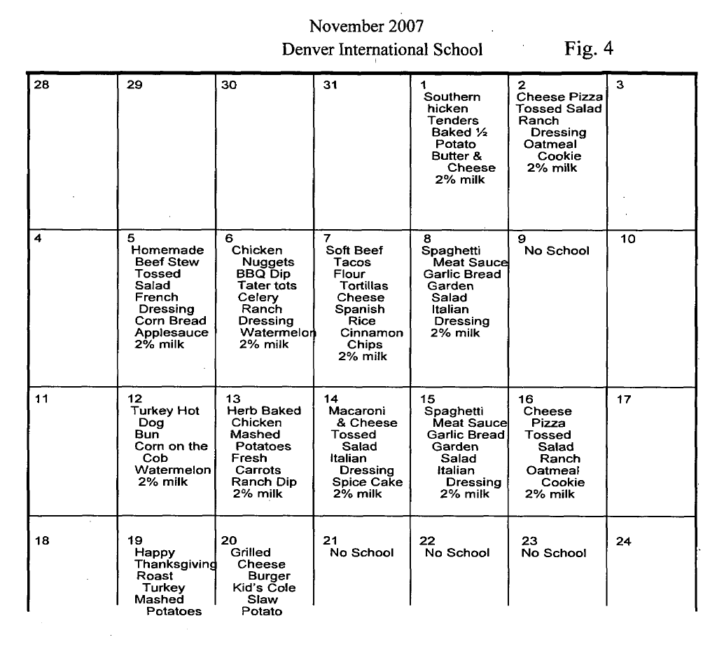

FIG. 3 is a screen view of an individual order detail calender module for a month. The individual in question has ordered a Super Sized Cheese Pizza order on Monday, Oct. 15, 2007, Drumsticks on Thursday the 18^{th}, 2007, and has no school on Friday, October 26^{th}. Note that this calender may serve double duty as the actual selection module for the individual. FIG. 4 is a screen view of a school menu calender module for a month. Whereas FIG. 3 has been winnowed down to the individual's selections, the November 2007 calender serves for the entire institution. And multiple options may be available, that is, there may be a choice of more than one entree, more than one different bread item and so on.

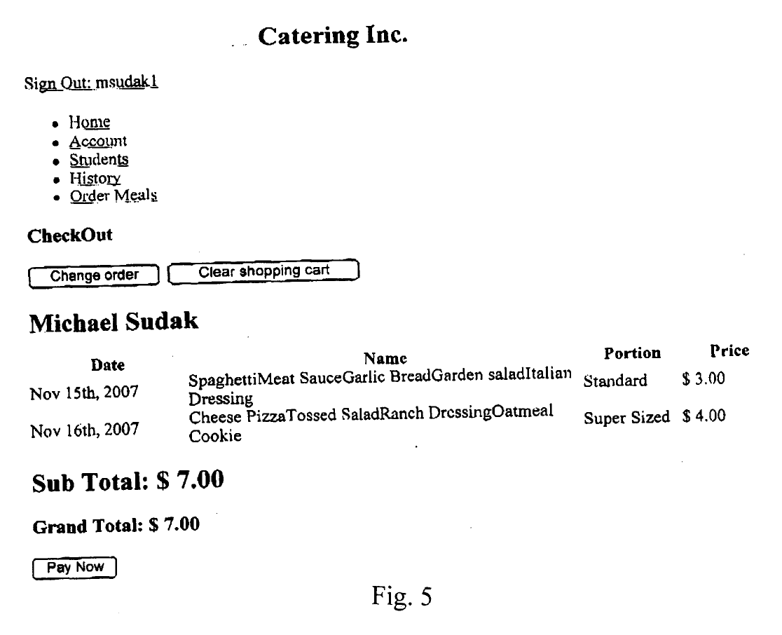

FIG. 5 is a screen view of an individual order detail showing details of cost and payment. This module may have functions relating to either or both of selection and payment: financial details are presented and a payment option is available, but the order may be changed as well.

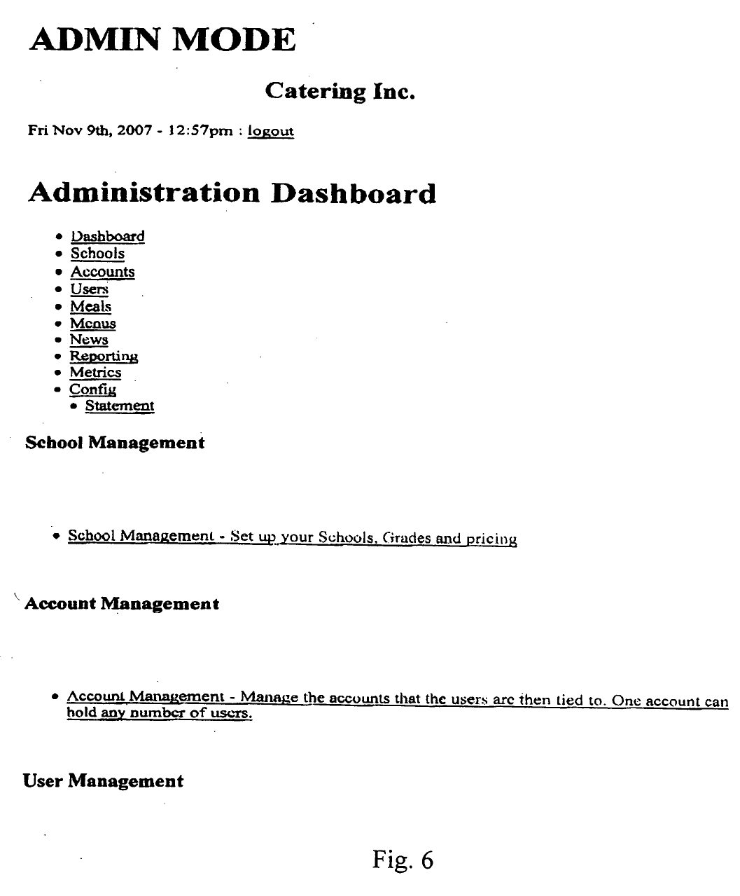

FIG. 6 is a screen view of an administrative function selection module showing various options for administrative management of the system of the invention. A fuller listing of these functions and/or modules is provided in TABLE TWO, below. In general, however, the administrative functions include control over school and individual accounts, as well as allowing creation of menus, provision of reports and metrics, provision of news as needed and obvious financial matters such as receipt of payments, billing, and the like.

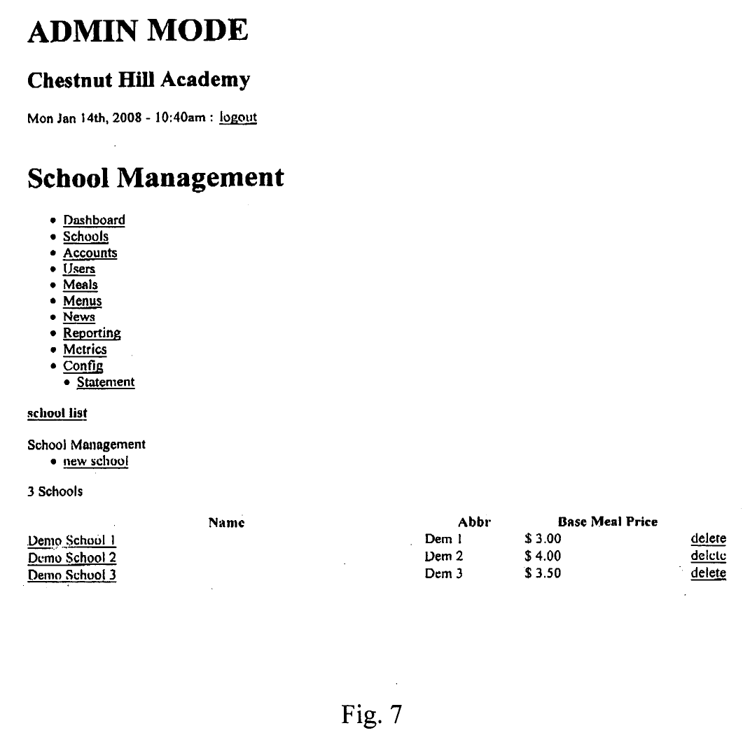

FIG. 7 is a screen view of a school management function selection module showing various options available for a school's administrative management of the system of the invention. As may be seen, the catering administrator may deal not just with individual accounts but with school/institute accounts. For example, base meal price may vary by school, as may menu choices. Thus school “A” may on day one have a menu set which includes entree “1” or entree “2” while school “B” on the same day may have a menu set which includes only entree “2”, and school “C” may have a menu set including entree “1” and “3”. More usually, menu choices will be “entree 1”, “vegetable 1”, “bread 1”, “dessert 1”, and the customer will select the parts of the meal desired, adding by themselves (brown bagging) whatever parts they did not desire from the offered menu.

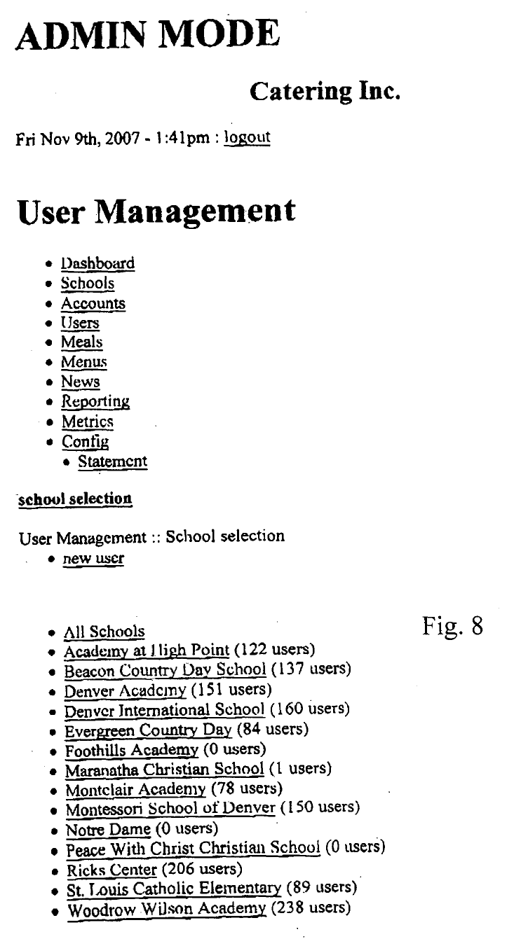

FIG. 8 is a screen view of an administrative management module controlling customer accounts on the system of the invention. In this case, school management functions for the catering administrator allow the administrator to drill down via the school to explore individual accounts: selecting school “D” may allow the administrator to examine and control the individual accounts associated with school “D”. Thus if customers of a particular school are presenting catering or billing challenges, the information may be collated in an easy to understand manner, allowing easier determination of steps necessary to correct such problems.

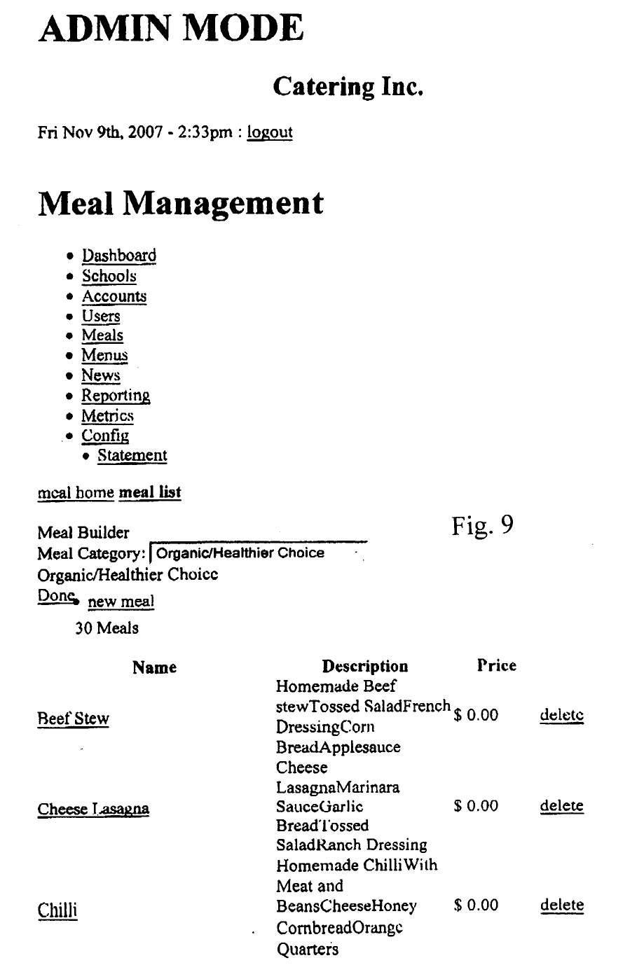

FIG. 9 is a screen view of a meal management module controlling building of meals on the system of the invention. In this module, the administrator (or potentially school administrators on a school account) may create the actual menus. Note that menus sets may themselves be part of supersets such as “Organic/Healthier Choice”, a group of menus which are individually more nutritious, while other menu options might include “Younger Pupils” (small portion sizes), “Older Pupils” and so on.

FIG. 10 is a screen view of a report module showing a single day and a single institution (school) and the menu choices of individual customers (students) at the institution. As can be seen, student “Chavez” has selected both the regular portion size for the entree and also the milk to drink, while student “Ford” has selected only the entree (Hot dog/Corn dog) and declined the milk. Students might also select different portion sizes. This report may be provided to the school administrators either by means of the delivery vehicle or simply by print out from the school/institute account, and the proper food may then be routed to the proper class rooms or students simply by consulting a list.

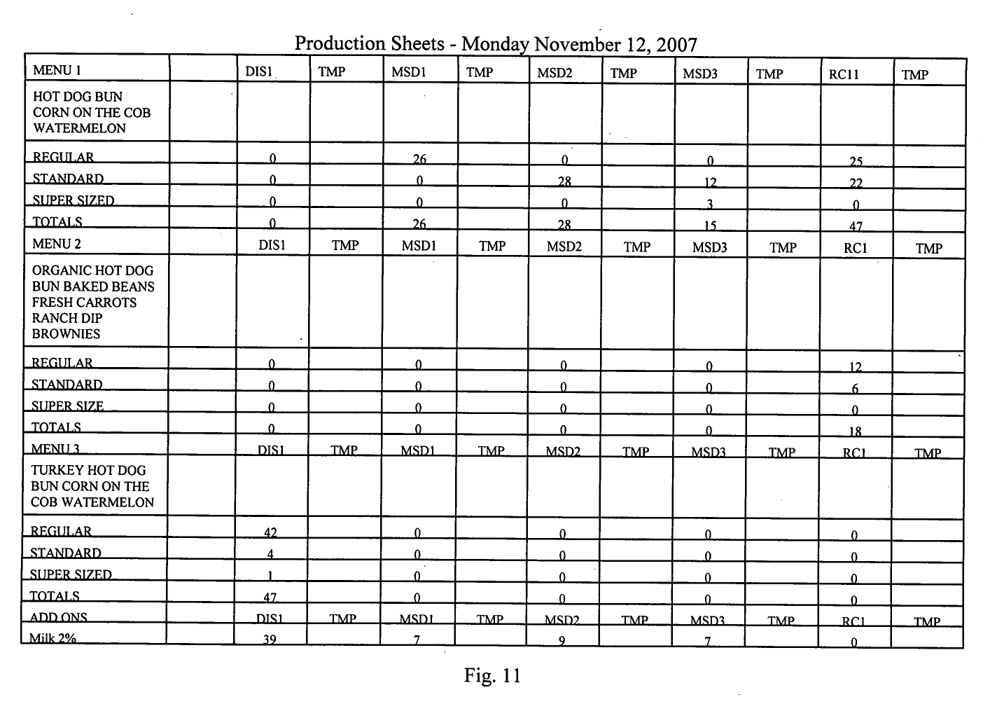

FIG. 11 is a screen view of a production sheet for kitchen use, showing the various items to be produced on a single day. The “prep sheet” allows the administrator to properly plan for the daily production, which may change from day to day depending on the vagaries of the large number of customers, weather, school activities and so on and so forth.
Michael: Tables One and Two are simply scans of the materials you sent me, which I'm presenting as lists of modules and functions in the system. However, they don't look good. Do you or your programmers have those as text files, for example, Microsoft Word documents or the like? I could quite easily cut and paste if we have those.

Table One shows the various functions (many embodied in modules) available to the individual customer using the system. Certain normal functions and modules include a login module (item nos. 1 and 2), accounts page, creation of a new user (item no. 7) and so on. Other modules are specific to the invention. For example, individual ordering of institutional meals by means of module 12 (see FIGS. 3 and 4) is novel. A calender of meals which actually allows users to select the desired meals on the desired days (item/module nos. 13 and 14) is another such example.

TABLE ONE
Hot Lunch Online Front End/Parent Log In

| | |
|---|---|
| 1. | Hot Lunch Online link is provided for client website; in this case Michael's of Denver |
| | Catering Inc. Guests click on link to go to Login page. |
| 2. | Login Page: Guests can login with their username and password or create an account if |
| | they do not have an account. Security question, login, and password rules are displayed. |
| 3-4. | Once logged in successfully the account homepage is displayed. Global, school and |
| | grade news articles are displayed as well as information on button pathways including: |
| | Account, Student, History, and Order Meals options. |
| 5. | Account Page: User may edit account information including login, security question and |
| | password. |
| 6. | Student Page: User may create and edit student and user information. |
| 7. | Create New User: A student is added to an account by choosing a school and grade. |
| 8. | History/Select a Student: User will select a student registered to their account. |
| 9. | History: User may access history of meals ordered. |
| 10-11. | History: Student's order history is displayed. |
| 12. | Order Meals: User can select student to order meals. |
| 13-14. | Calendar: Menu choices are presented on a monthly calendar. The user selects |
| | meal items, and then clicks CHECKOUT. |
| 15. | Checkout: This page displays choices and prices including totals. The user may change |
| | an order, clear shopping cart or continue to Paypal or other payment processor. |
| 16. | Pay Now: This page links the user to Paypal which all payments are accepted |
| | through. The user may then print a receipt. |

END TABLE ONE

Table two on the other hand presents a wide range of options available to the system administrator in the catering organization.

In general, management functions can be seen in several broad categories.

School management functions such as those seen under item nos. 7, 8 and 9 invoke modules which allow the administrator to control entire school functions, such as adding a new school when a new school signs up for the catering service of the invention.

Schools may in turn be broken down by class and grade, using module nos. 12, 13 et seq., and these grades administered individually as well.

Customer accounts (termed “users”) may also be controlled directly from the administrator's “dashboard” or overview module. For example, a new user may be added, and old user/customer may be deleted, reports about users at a particular school may be generated and so on. Note that in alternative embodiments, this authority may be vested in the institutional administrators, that is, the school officials: when adding a new pupil, they might log onto a school account and add the new student to the catering system. However, the access by relatively unfamiliar personnel to a system such as this is less desirable than embodiments in which the central catering administration carries out such tasks at the request of school authorities.

Meal category modules serve a unique purpose: allowing the catering organization administrator to create menus by category, school, item by item or as otherwise is desirable.

A broad range of reporting options, news options and other ancillary functions may also be supported by the invention.

TABLE TWO
Administration

| | |
|---|---|
| 1. | Administrators log in: Users must log in with username, password and security code |
| 2.-5. | Home Page displays Dashboard, including buttons and brief descriptions for: Schools, |
| | Accounts, Users, Meals, Menus, News, Reporting, Metrics, Configuration and |
| | Statements. Also displayed are two fusion charts. |
| 6. | Schools button displays current school names, abbreviations and meal prices. Add School |
| | Button. |
| 7. | New Schools: enables user to add new schools information and save it in the database, |
| | including name, abbreviation, meal price, contact name, email, phone and fax numbers. |
| 8. | School List: enables user to select a school by clicking on display and reading school |
| | information, location information and grade information. |
| 9. | Edit School: displays school information in edit mode. User may edit name, |
| | abbreviation, meal price, contact name, contact email, contact phone, contact fax and |
| | submit changes. |
| 10. | Edit Location by clicking on location, name page. Displays location information in edit |
| | mode. User may edit location name, abbreviation, address one, address two, city, state |
| | and ZIP code. Save changes with submit button. |
| 11. | New Location: button enables user to add a location to a school, including location name, |
| | abbreviation, address one, address two, city state, ZIP and submit changes. |
| 12. | Edit Grade by clicking on Grade Name. Page will display grade information, in edit |
| | mode, including name, location, order method, monthly ordering, cutoff date and price |
| | outline. |
| 13. | New Grade button enables user to add a grade to a school, including name, |
| | location, order method, monthly ordering, cutoff date and price outline. |
| 14. | Reorder Grade Button will allow user to change the order in which the grades are |
| | displayed. Done Button will save changes. |
| 15. | Accounts page will display all accounts, their email address and users, plus a total |
| | number of accounts. The search button will search alphabetically for account names. |
| 16.-17. | Account View button will link user to the account data, including log in, email, |
| | manual entry locked, locked message, security question and answer, users, login |
| | history, created date, modified date history, and recent history of purchases, |
| | including paypal transaction number, date, submission to paypal and confirmation |
| | of purchase. |
| 18-19. | New Account button allows user to add an account, including login, password, |
| | email address, lock account and locked account message. |
| 20. | Users button page displays number of users at each school and new user button. |
| 21. | New Users: allows user to input new user information, including account name, school, |
| | grade, last and first name. |
| 22. | User list is created by clicking on the school displayed on the user page or user may |
| | search alphabetically. |
| 23-24. | Search will yield alphabetical matches in their school. User may click on match to link to |
| | view account or email. |
| 25. | Meal button: meal management displays four functions: Categories, Portions, Meal |
| | Builder, and Meal add-ons with brief definitions. |
| 26. | Meal Category management displays names of meal categories and Add Meal |
| | category button. |
| 27. | Add Meal category button allows user to add the name of a meal category, make |
| | category orderable and submit to store. |
| 28. | Edit Meal Category allows user to change name or orderable status of selected meal |
| | category and submit changes or cancel changes. |
| 29. | Portions page displays name of portions, price offset, delete and add new portions button. |
| 30. | Add Meal Portion button allows User to add a meal portion name and price offset and |
| | submit to save changes. |
| 31. | Meal Portion Edit Button allows user to select a portion and edit name and price offset; |
| | submit to save changes. |
| 32-35. | Meal Builders Page displays meals, descriptions, price offset and delete option for |
| | a selected category of meals. Use this button for adding new meals. |
| 36-37. | New Meal button allows user to add a meal, including meal name, price override, |
| | description and toolbar. Submit button to save changes. |
| 38-39. | Meal Edit; by clicking on a meal, user can edit mea name, price and description. |
| | Submit button to save changes. |
| 40-41. | Add On: displays names of add on items, prices, delete and add new add on |
| | buttons. |
| 42. | Add Meals: Add On allows users to add meals, add on name, price; submit to save |
| | information. |
| 43. | Meal Add On or Edit: Allows user to edit add on name, price and submit to save |
| | changes. |
| 44. | Menu Management page allows users to select master menu or school menu. |
| 45-46. | Master Menu page allows user to create a master menu by clicking on blank dates, |
| | select meals from meal category and add ons. |
| 47. | Menu can be transferred to selected school from drop down list. |
| 48. | School menu page allows user to edit school menu by adding or removing meals and |
| | meal add ons. |
| 49. | News Button allows user to select three news management selections: global, school and |
| | grade. |
| 50. | Global News List displays headline and date from current global news and new global |
| | news button. |
| 51. | New Global News Item allows user to create headlines and description or text. Includes |
| | tool box. |
| 52. | School News Management displays headline and date from current school news and new |
| | school news button. |
| 53. | New School News allows user to select school and create headline, text and use tool box. |
| 54. | Grade News Management allows users to select school and grade to view current grade |
| | news. |
| 55. | Select school and grade will display current grade news and date with new grade items |
| | button. |
| 56. | New Grade News allows user to create, headline and text fro new grade news and |
| | includes tool bar. |
| 57. | Reporting button allows user to select reports including production sheet, student order |
| | list account email list, and student monthly order list. |
| 58. | Production report allows you to select beginning and ending dates for production report to |
| | download. |
| 59-64. | Production report us downloaded in an Excel spreadsheet and displays school |
| | names, menus, add ons, portion sizes, subtotals, totals and server checkoff list. |
| 65. | Student order list allows user to select school and dates and page groupings of report. |
| 66. | Student order list is downloaded as a PDF and lists students names and orders in |
| | alphabetical and grade order. |
| 67. | Account email list allows user to select school and date range; filters for those that have |
| | ordered meals or those that have not; displays emails to copy and paste in host email |
| | account. |
| 68. | Student monthly order list allows user to select school and dates of orders. |
| 69. | Student Monthly Order List prints in alphabetical order all orders placed during the time |
| | period. |
| 70. | Metrics button displays choice of visual graphs; 50 most ordered meals and monthly |
| | order comparison. |
| 71. | Fifty most ordered meals displays fusion chart illuminating exact number of each menu |
| | item ordered. |
| 72. | Monthly Order Comparison displays fusion chart of numbers of meals ordered monthly. |
| 73. | Configuration Management allows users to select general configuration, order methods |
| | and order policies. |
| 74-75. | General Configuration allows user to input Business Data, Time Zone, Definitions |
| | of Entity Division, Account and User; Calendar Publishing and select Calendar |
| | Days available. |
| 76. | Order Method List displays order methods and new order methods button. |
| 77. | New Order Method button allows users to name and describe new order methods. |
| 78-79. | Order Policies allows user to describe policies and procedures and includes |
| | toolbar and submit button. |
| 80. | Statement allows user to select dates and produce statement of orders and Paypal (TM) |
| | charges. |

END TABLE TWO

The disclosure is provided to allow practice of the invention by those skilled in the art without undue experimentation, including the best mode presently contemplated and the presently preferred embodiment. Nothing in this disclosure is to be taken to limit the scope of the invention, which is susceptible to numerous alterations, equivalents and substitutions without departing from the scope and spirit of the invention. The scope of the invention is to be understood from the appended claims.

What is claimed is:

1. A catering method for individual customers of a first institution with which the individual customers are associated, the catering method comprising the steps of:
0) provision of a catering system operative to communicate with such individual customers, a first caterer, and such first institution;
1) provision via such catering system by the first caterer to such individual customers of a schedule and a set of menu items associated with such first institution;
2) selection via such catering system by such customers of a subset of the menu items;
3) return via the catering system by the customers of the selected subset to the caterer, not the institution;
4) payment via the catering system by the customers to the caterer;
5) provision of the selected subset of the menu items by the caterer to the institution according to the schedule.

2. The catering method of claim 1, wherein the step of provision of a schedule and a set of menu items associated with such first institution further comprises:
provision of a website having the schedule and set of menu items thereon; and
provision of customer accounts individually associated with the customers of the institution.

3. The catering method of claim 2, wherein the step of selection of a subset of the menu items further comprises:
provision of a selection module of such customer accounts, the selection module operative to allow selection of the subset; and
provision of an administrator account operative to receive such selections.

4. The catering method of claim 2, wherein the step of payment further comprises:
provision of a payment module of such customer accounts operative to allow electronic payment by the customer to the caterer without intervention of the institution.

5. The catering method of claim 1, further comprising:
a second catering institution and provision via such catering system by the first caterer to such individual customers of a schedule and a set of menu items associated with such first institution.

6. The catering method of claim 1, wherein:
the first catering institution and the catering system are combined.
Michael: claim 5 covers having multiple caterers separate from the system, while claim 6 on the other hand covers the case in which the caterer and the system are the same.

7. A catering system for use by individual customers of a first institution with which the individual customers are associated, the catering system comprising:
a food preparation center having a delivery vehicle operative to deliver prepared food to such institution;
a website having thereon a schedule, a set of menu items associated with the schedule, and at least one individual account associated with each such individual customer, the individual account associated with each such individual customer further comprising a payment module operative to provide payment from the individual customer to an administrative account, the administrative account having a food preparation module operative to provide food preparation information to the food preparation center.

8. The catering system of claim 7, further comprising:
a menu preparation module operative to provide the schedule and set of menu items associated therewith.

9. The catering system of claim 7, further comprising:
an administrative customer account management module operative to setup and control individual customer accounts.

10. The catering system of claim 7, further comprising:
an institution management module operative to control an institution account associated with each institution.

11. The catering system of claim 7, further comprising:
a meal management module operative to allow creation of the set of menu items for later customer selection.

12. The catering system of claim 7, further comprising:
a report module operative to provide a report selected from the group consisting of: customer menu selections by date and institution; food production necessary to fulfill customer menu selections by date; food production necessary to fulfill customer menu selections by institution; financial accounting reports and combinations thereof.
